(19) United States
(12) Patent Application Publication
(10) Pub. No.: US 2016/0016505 A1
(43) Pub. Date: Jan. 21, 2016

(54) Auxiliary Lighting Device for Car

(71) Applicant: Chin-Shu Yin, Tainan City (TW)

(72) Inventors: Chin-Shu Yin, Tainan City (TW); Wei-Fang Chen, Tainan City (TW)

(21) Appl. No.: 14/332,429

(22) Filed: Jul. 16, 2014

(51) Int. Cl. B60Q 1/24; B60Q 1/00; B60Q 1/04

(52) U.S. Cl. CPC B60Q 1/24; B60Q 1/04; B60Q 1/0082

(57) ABSTRACT

An auxiliary lighting device includes two headlight units and two side light units located beside the headlight units respectively. Each of the side light units includes a housing arranged beside the respective headlight unit and located adjacent to a side corner of a head of a car, and an auxiliary light mounted in the housing. The housings of the side light units are arranged and directed outward so that the auxiliary lights of the side light units light in two directions. The auxiliary light of each of the side light units is connected to a turn signal switch of the car. Thus, the auxiliary light of one of the side light units is turned on to emit light beams toward and illuminate the zone to be turned.

### BACKGROUND OF THE INVENTION

1. Field of the Invention

The present invention relates to an auxiliary lighting device and, more particularly, to an auxiliary lighting device for a wheeled vehicle, such as a car and the like.

2. Description of the Related Art

A conventional turning lighting mechanism for a car comprises a motor having an end provided with a reducer which has an end provided with a shaft, a beveled drive gear connected with the shaft of the reducer, a rotary disk having a bottom provided with a beveled driven gear meshing with the beveled drive gear, a gear box for mounting the beveled drive gear, the rotary disk and the beveled driven gear, two optical detectors mounted on the front portion and side face of the gear box, a microswitch mounted on a side of the beveled drive gear and having a first end provided with a contact lever and a second end provided with a switch, an angle limit bar located at a side of the beveled drive gear to limit the rotation angle of the rotary disk, and a lamp mounted above the rotary disk. The two optical detectors can turn on the lamp automatically when the lightness of the car is changed. Thus, when the driver turn the car, the conventional turning lighting mechanism automatically provides an illumination in the turning direction of the car. However, the lamp cannot be turned previously toward the zone to be turned before the car is turned or steered, so that the driver cannot clearly see the road situation of the zone to be turned, thereby easily causing danger to the driver. In addition, the conventional turning lighting mechanism has a complicated structure, thereby increasing the cost of fabrication.

### BRIEF SUMMARY OF THE INVENTION

The primary objective of the present invention is to provide an auxiliary lighting device having an enlarged lighting sweep or field.

In accordance with the present invention, there is provided an auxiliary lighting device comprising two headlight units and two side light units located beside the headlight units respectively. Each of the side light units includes a housing arranged beside the respective headlight unit and located adjacent to a side corner of a head of a car, and an auxiliary light mounted in the housing. The housings of the side light units are arranged and directed outward so that the auxiliary lights of the side light units light in two directions. The auxiliary light of each of the side light units is connected to a turn signal switch of the car. When a driver wishes to park the car at night, the driver selects the auxiliary light of one of the side light units to illuminate a zone to be turned, so as to enlarge a field of vision of the driver. When the car is driven in a mountain or in a dense fog at night, the auxiliary lights of the side light units light in two directions to illuminate a right-side zone and a left-side zone respectively so as to enlarge the field of vision of the driver.

According to the primary advantage of the present invention, the auxiliary light of one of the side light units is turned on to emit light beams toward and illuminate the zone to be turned, so as to enlarge the field of vision of the zone to be turned, thereby facilitating the driver clearly viewing the road situation of the zone to be turned, and thereby cautioning a following driver behind the car 8.

According to another advantage of the present invention, the auxiliary lights of the side light units can be turned on simultaneously and emit light beams toward a right-side zone and a left-side zone respectively so as to illuminate the road at the right-side zone and the left-side zone, thereby greatly enhancing the driver's safety when driving in the mountain or in a dense fog at night.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a top cross-sectional view of an auxiliary lighting device for a car in accordance with the preferred embodiment of the present invention.

FIG. 2 is a schematic operational view of the auxiliary lighting device as shown in FIG. 1.

FIG. 3 is another schematic operational view of the auxiliary lighting device as shown in FIG. 1.

FIG. 4 is another schematic operational view of the auxiliary lighting device as shown in FIG. 1.

FIG. 5 is another schematic operational view of the auxiliary lighting device as shown in FIG. 1.

FIG. 6 is a top cross-sectional view of an auxiliary lighting device for a car in accordance with another preferred embodiment of the present invention.

FIG. 6a is a locally enlarged view of the auxiliary lighting device as shown in FIG. 6.

FIG. 7 is a schematic operational view of the auxiliary lighting device as shown in FIG. 6.

### DETAILED DESCRIPTION OF THE INVENTION

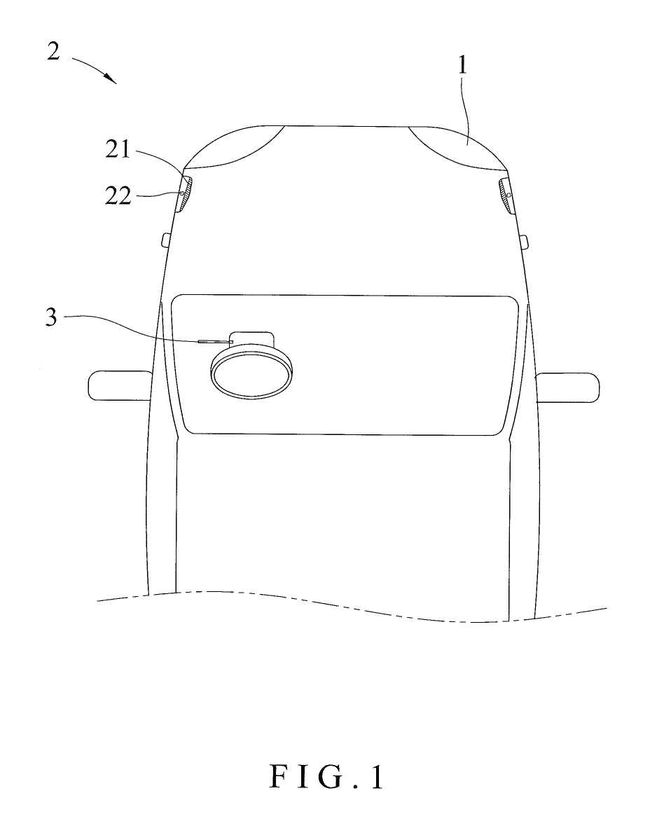

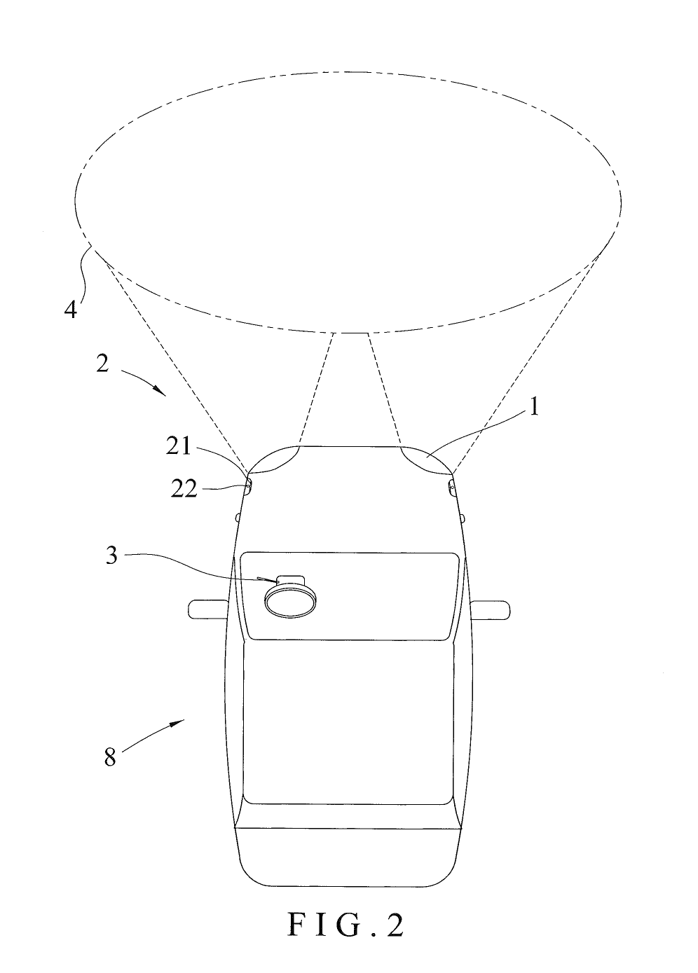

Referring to the drawings and initially to FIGS. 1 and 2, an auxiliary lighting device in accordance with the preferred embodiment of the present invention comprises two headlight units 1 and two side light units 2 located beside the headlight units 1 respectively.

Each of the side light units 2 includes a housing 21 arranged beside the respective headlight unit 1 and located adjacent to a side corner of a head of a car 8, and an auxiliary light 22 mounted in the housing 21. The housings 21 of the side light units 2 are arranged and directed outward so that the auxiliary lights 22 of the side light units 2 light in two directions. The auxiliary light 22 of each of the side light units 2 is connected to a turn signal switch 3 of the car 8.

In operation, referring to FIG. 2 with reference to FIG. 1, when the car 8 is driven at night, the headlight units 1 are turned on as shown in FIG. 2 to emit light beams toward a front zone 4 so as to illuminate the front zone 4.

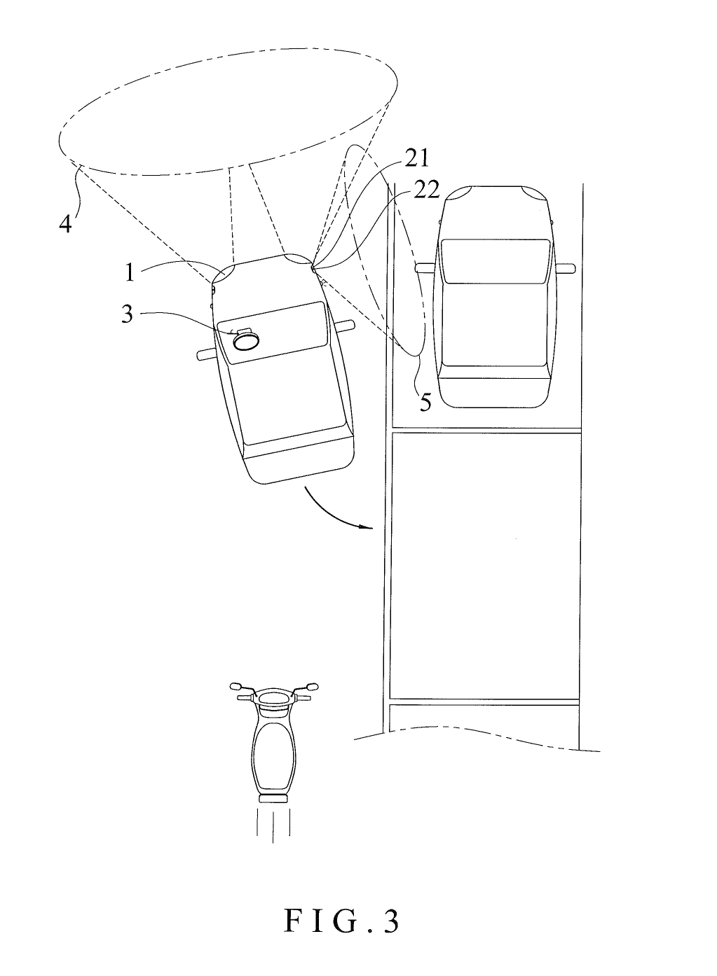

Alternatively, referring to FIG. 3 with reference to FIGS. 1 and 2, when the driver wishes to park the car 8 at night, the turn signal switch 3 is started by the driver, and the auxiliary light 22 of one of the side light units 2 at the right-side of the car 8 is turned on simultaneously and emits light beams toward a right-side zone 5 so as to illuminate the road at the right-side zone 5 and to enhance the field of vision of the right-side zone 5, thereby facilitating the driver clearly watching the road situation of the right-side zone 5, and thereby warning a following driver behind the car 8.

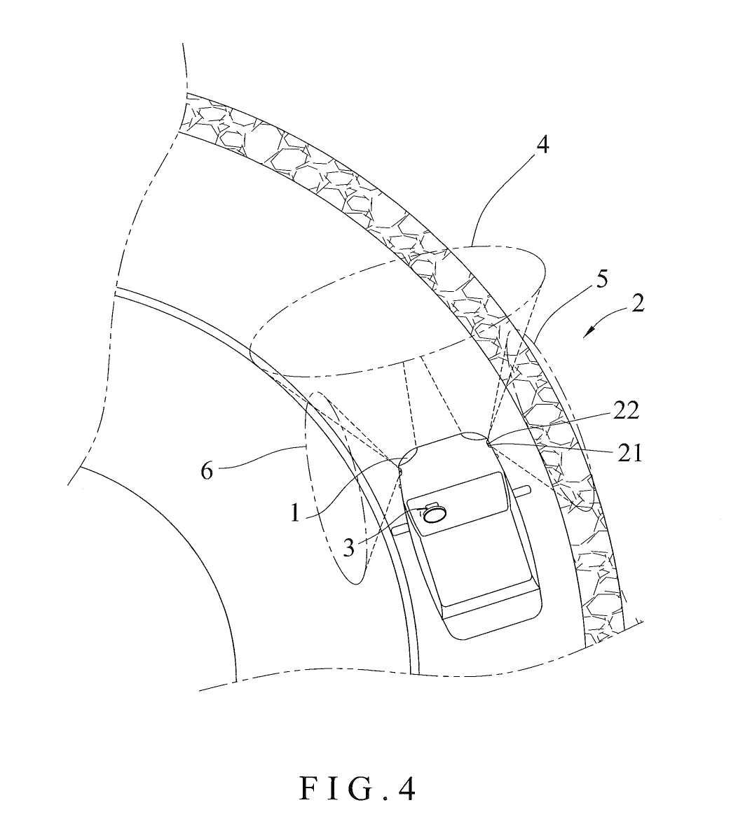

Alternatively, referring to FIG. 4 with reference to FIGS. 1 and 2, when the car 8 is driven in the mountain or in a dense fog at night, the auxiliary lights 22 of the side light units 2 are turned on simultaneously and emit light beams toward a right-side zone 5 and a left-side zone 6 respectively so as to illuminate the road at the right-side zone 5 and the left-side zone 6, thereby greatly enhancing the driver's safety when driving in the mountain or in a dense fog.

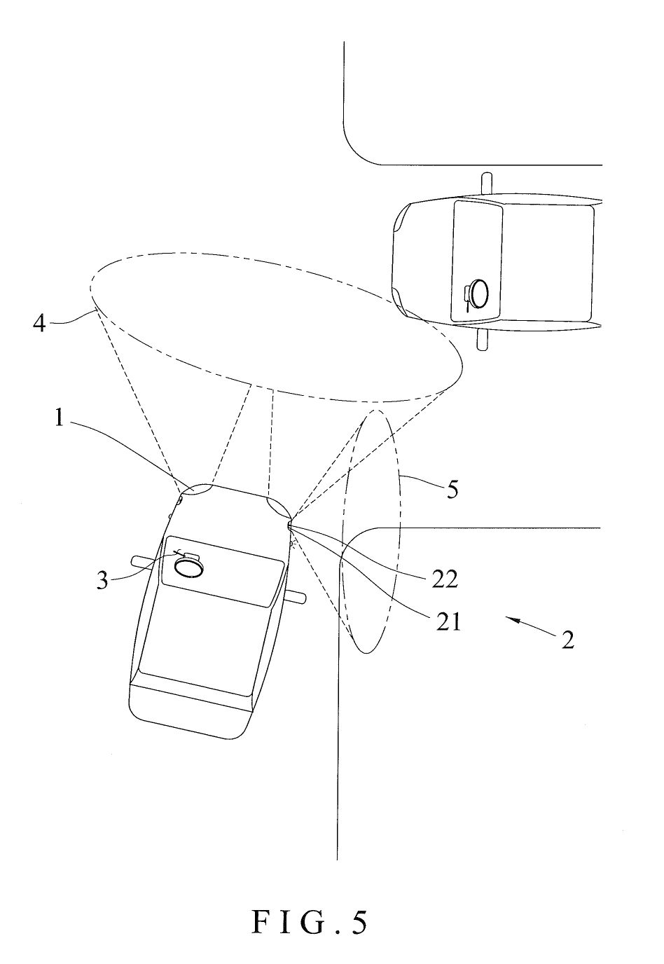

Alternatively, referring to FIG. 5 with reference to FIGS. 1 and 2, when the driver wishes to turn right the car 8, the turn signal switch 3 is started by the driver to turn on and blink a right-side turn signal of the car 8, and the auxiliary light 22 of one of the side light units 2 at the right-side of the car 8 is turned on simultaneously and emits light beams toward the right-side zone 5 so as to illuminate the road at the right-side zone 5 and to enhance the field of vision of the right-side zone 5, thereby facilitating the driver clearly viewing the road situation of the right-side zone 5, and thereby warning a following driver behind the car 8.

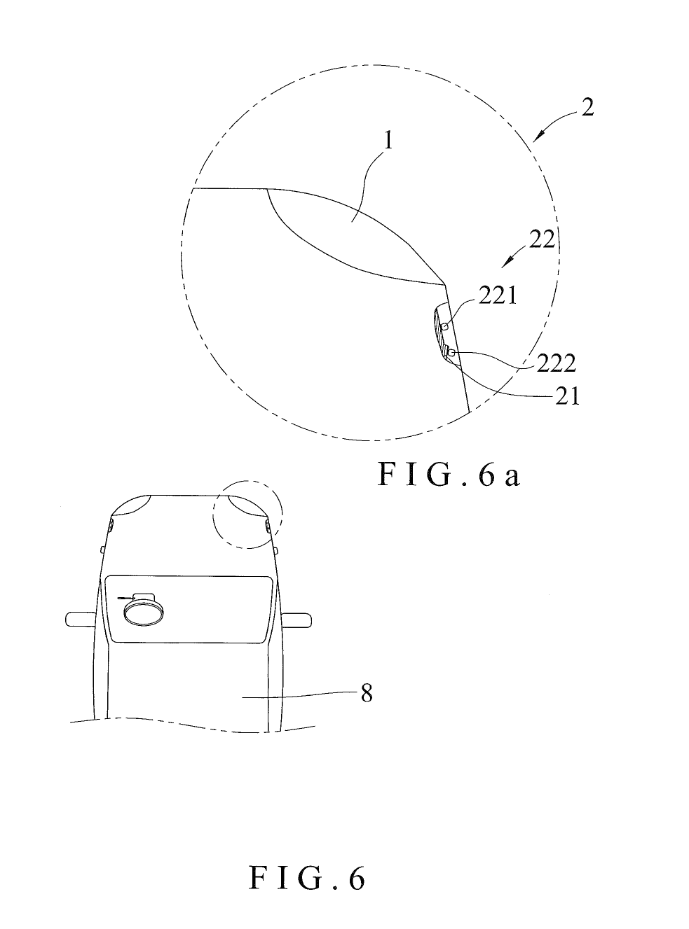

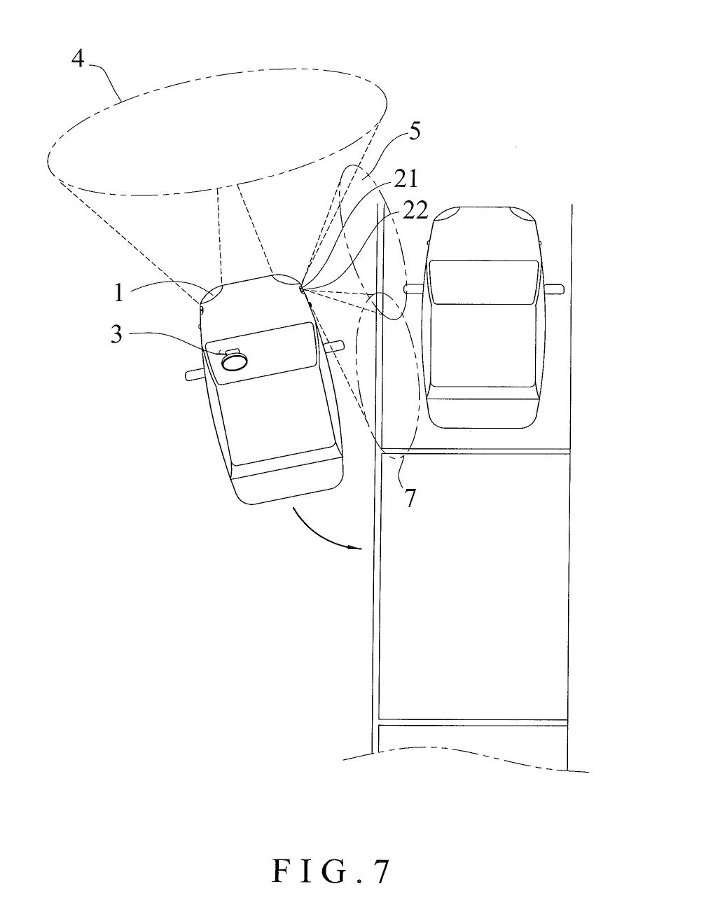

Referring to FIGS. 6, 6a and 7, the auxiliary light 22 of each of the side light units 2 includes a low beam 221 located beside the respective headlight unit 1 and a high beam 222 located beside the low beam 221, with the low beam 221 being located between the respective headlight unit 1 and the high beam 222. In operation, when the driver wishes to park the car 8, the turn signal switch 3 is started by the driver, and the auxiliary light 22 of one of the side light units 2 at the right-side of the car 8 is turned on simultaneously. In such a manner, the low beam 221 of the auxiliary light 22 emits light beams toward a right-side zone 5 so as to illuminate the road at the right-side zone 5, while the high beam 222 of the auxiliary light 22 emits light beams toward a right-side rearward zone 7 so as to illuminate the road at the right-side rearward zone 7, so as to enhance the field of vision of the driver.

Accordingly, the auxiliary light 22 of one of the side light units 2 is turned on to emit light beams toward and illuminate the zone to be turned, so as to enlarge the field of vision of the zone to be turned, thereby facilitating the driver clearly viewing the road situation of the zone to be turned, and thereby cautioning a following driver behind the car 8. In addition, the auxiliary lights 22 of the side light units 2 can be turned on simultaneously and emit light beams toward a right-side zone 5 and a left-side zone 6 respectively so as to illuminate the road at the right-side zone 5 and the left-side zone 6, thereby greatly enhancing the driver's safety when driving in the mountain or in a dense fog at night.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. An auxiliary lighting device comprising:
two headlight units; and
two side light units located beside the headlight units respectively;
wherein:
each of the side light units includes:
a housing arranged beside the respective headlight unit and located adjacent to a side corner of a head of a car; and
an auxiliary light mounted in the housing;
the housings of the side light units are arranged and directed outward, with the auxiliary lights of the side light units lighting in two directions;
the auxiliary light of each of the side light units is connected to a turn signal switch of the car;
when a driver wishes to park the car at night, the driver selects the auxiliary light of one of the side light units to illuminate a zone to be turned, so as to enlarge a field of vision of the driver; and
when the car is driven in a mountain or in a dense fog at night, the auxiliary lights of the side light units light in two directions to illuminate a right-side zone and a left-side zone respectively so as to enlarge the field of vision of the driver.

2. The auxiliary lighting device of claim 1, wherein the auxiliary light of each of the side light units includes a low beam located beside the respective headlight unit and a high beam located beside the low beam.
